(19) United States
(12) Patent Application Publication
(10) Pub. No.: US 2011/0038995 A1
(43) Pub. Date: Feb. 17, 2011

(54) INTERMEDIATE MOISTURE SHELF STABLE BAKED GOODS

(75) Inventors: Daniera Z. Thulin, Budd Lake, NJ (US); Richard A. Couttenye, New York, NY (US); Edward C. Coleman, New Fairfield, CT (US)

Correspondence Address: FITCH EVEN TABIN & FLANNERY, 120 SOUTH LASALLE STREET, SUITE 1600, CHICAGO, IL, 60603-3406, US

(73) Assignee: KRAFT FOODS GLOBAL BRANDS LLC, Northfield, IL (US)

(21) Appl. No.: 12/540,140

(22) Filed: Aug. 12, 2009

(51) Int. Cl. A23L 1/035; A23L 3/3454

(52) U.S. Cl. 426/310; 426/654

(57) ABSTRACT

A shelf stable intermediate moisture baked food product having moisture retention and migration control and methods of manufacture is provided. In one embodiment, the shelf life extending moisture control system for an intermediate moisture developed food composition has a humectant blend, a hydrocolloid blend, and a hydrophobic blend. Another embodiment provides developed food composition having a water activity (A_{W}) range of about 0.5 to 0.75. A method to manufacture a food composition can first develop a humectant/hydrocolloid matrix, then coating it with a hydrophobic oil/emulsifier blend. This hydrophobic surface coating on an already formed matrix creates a desired moisture barrier, while the humectants/hydrocolloids inhibit moisture migration.

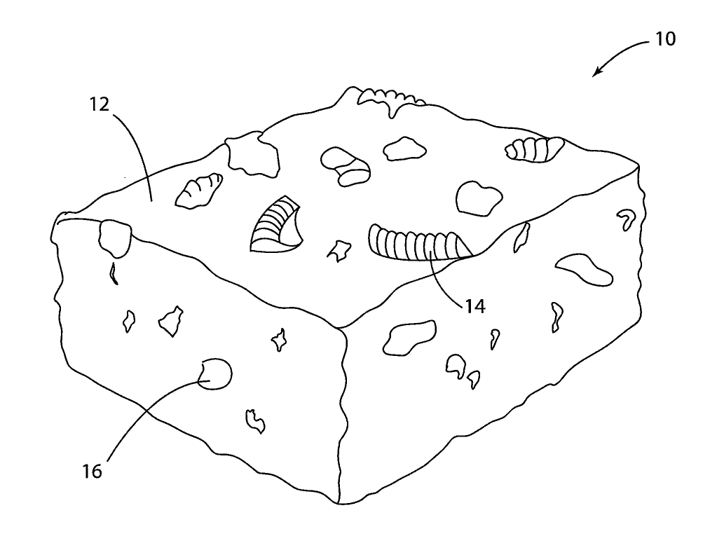

### FIELD

This application relates to intermediate moisture baked food products, and specifically to intermediate moisture baked food products formulated and manufactured to control moisture retention and migration and to extend shelf life without antimicrobial or preservative systems.

### BACKGROUND

Intermediate moisture baked food products, such as brownies, blondies, sponge cakes, muffins, cupcakes, pan cakes, breads, and the like, typically have a water activity (A_{W}) range of about 0.5 to 0.75 prior to packaging. Water activity can be described as the ratio of the fugacity of water in a system being studied to the fugacity of pure water at the same temperature measured using physical and chemical techniques and instruments known in the art. For a variety of reasons, control of water activity can be important in packaged baked food products.

To provide an organoleptically acceptable product to consumers, maintaining a specified moisture level and texture in a packaged food product is important throughout its shelf life. Shelf life can be described as the length of time a food product may be stored and be still suitable for consumption. More specifically, shelf life can refer to the number of days after baking that the product substantially retains its flavor profile, texture characteristics, bacterial deterioration, and is free from visible mold growth.

It can also be important to control moisture migration among food product components of varying desired moisture content during shelf life. A particular challenge occurs when a baked food product has components that vary widely by moisture activity and it is organoleptically desired to maintain the variation within the product. This can be especially difficult for products during an extended shelf life. A further issue is recent consumer demand to reduce the use of preservatives or antimicrobial systems in food products, including shelf stable food products.

Attempts are known in the art to use hydroscopic substances such as humectants to improve shelf life of baked goods by keeping them moist and/or reducing moisture migration. A humectant can be some types of hydrocolloid (e.g., having hydroxyl groups to form hydrogen bonds with water) or a combination of hydrocolloids (such as maltodextrin or hydroxyl propyl methyl cellulose) to manage moisture migration in food products. It is noted though that not all hydrocolloids are humectants. Many can be used to structure water, such as gelling or increasing viscosity. Also, hydrocolloids combined with amino acids and hydrophobic components (such as L-cysteine and/or lipids such as monoglyceride) are also known in dough conditioners (See, U.S. Pub. 2007/0020369 to Roy et al.). Other components have also been attempted to slow moisture loss and migration in baked goods. For example, U.S. Pat. No. 6,217,930 to Kilibwa states that adding relatively large amounts of trimethylglycine (a betaine) before baking improved moisture retention and organoleptics in baked goods, such as bread, preferably having a water activity less than 0.65. In Kilibwa, fat content, such as edible triglycerides, also ranged between 2 to 35 percent dry weight.

While there have been significant advances in the art, further advances are possible and desired. An extended shelf life intermediate moisture baked food product that can remain organoleptically acceptable for consumer use while maintaining moisture characteristics, and even multiple moisture characteristics, is desired. It would be especially desirable to develop such a product without need or use of a preservative or antimicrobial system and without need of additional processing steps after baking.

### SUMMARY

Accordingly, there is provided herein a shelf stable intermediate moisture baked food product having moisture retention and migration control and methods of manufacture. One embodiment can be a shelf stable intermediate moisture baked food product having a shelf life of at least six months. The present food product includes a combination of humectants and lipids that allow moisture management without the need for antimicrobial or preservative systems.

In one embodiment, the shelf life extending moisture control system for an intermediate moisture developed food composition has a humectant blend, a hydrocolloid blend, and a hydrophobic blend. The humectant blend can be glycerine, propylene glycol, glyceryl triacetate, polyols, xylitol, maltitol, polymeric polyols, polydextrose, natural extracts of quillaia, natural extracts of lactic acid, and the like. The hydrocolloid blend can be xanthan gum, guar gum, alginates, cellulose gums, maltodextrin and hydroxyl propyl methyl cellulose, and the like. The hydrophobic blend can be any edible lipid.

In one specific embodiment, humectant blend has about 0.001 to 14 percent weight glycerine and about 0.51 to 3 percent weight polydextrose; the hydrocolloid blend has about 0.001 to 0.1 percent weight xanthan gum, about 0.001 to 0.3 percent weight sodium alginate, and about 0.001 to 0.50 percent weight methyl cellulose; and the hydrophobic blend has about 0.24 to 1.9 percent weight non-hydrogenated shortening, about 1.69 to 13.5 percent soy bean oil+TBHQ (tertiary-butylhydroquinone), about 0.36 to 2.85 percent weight emulsifier, and about 0.36 to 2.85 percent weight liquor.

Another embodiment provides a shelf life extending moisture control system for an intermediate moisture developed food composition having food ingredients and water. The food composition can have about 94.7 to 26.9 percent weight food ingredients; about 2.5 to 35 percent weight water; about 0.52 to 17 percent weight humectant blend; about 0.003 to 0.9 percent weight hydrocolloid blend; about 2.3 to 20.2 percent weight hydrophobic blend; and wherein the composition has a water activity (A_{W}) range of about 0.5 to 0.75.

A method to manufacture a food composition can first develop a humectant/hydrocolloid matrix, then coating it with an hydrophobic oil/emulsifier blend. This hydrophobic surface coating on an already formed matrix creates a desired moisture barrier, while the humectants/hydrocolloids inhibit moisture migration.

Other features will become more apparent to persons having ordinary skill in the art from the following description and claims.

### BRIEF DESCRIPTION OF THE FIGURES

The foregoing features, as well as other features, will become apparent with reference to the description and FIGURE below, in which like numerals represent like elements, and in which the FIGURE is an illustration of an embodiment of a shelf stable intermediate moisture baked food product.

### DETAILED DESCRIPTION

The embodiments described below provide a shelf stable intermediate moisture baked food product having moisture retention and migration control in a shelf stable intermediate moisture baked food product and methods of manufacture. The product can be combination of humectants and lipids that allow moisture management without need of antimicrobial or preservative systems and have a shelf life of at least six months.

As described herein, the term “baked goods” is understood by its definition in 21 C.F.R. 170.3 to include ready-to-eat baked products and can generally including cakes, crackers, cookies, brownies, muffins, rolls, bagels, strudels, pastries, croissants, biscuits, bread, and bread products (e.g., pizza), buns, and the like. Intermediate moisture baked goods can generally include food products having a water activity range of about 0.5 and 0.75 prior to packaging such as brownies, blondies, sponge cakes, muffins, cupcakes, pan cakes, breads, and the like.

Generally, the products and method of manufacture described herein combine a humectant blend and a hydrophobic blend with food ingredients added together in a particular order to achieve an extended shelf life with desired organoleptic characteristics, including maintaining water activity levels of varying components. The FIGURE shows one embodiment of such a product and is generally shown at 10.

Product 10 shows a brownie product as an example only of an intermediate moisture baked food product. Brownie product 10 has a brownie component 12 with ground crunchy cookie pieces 14 and confectionary droplets 16 dispersed therein. In alternate embodiments, ground crunchy cookie pieces 14 can be placed only on the top of brownie component 12. In this example, brownie component 12 can have a water activity level of between 0.5 to 0.75, and ground crunchy cookie pieces 14 can have a water activity range 0.2 to 0.3. The formulation and method of manufacture of the product as described below allows brownie component 12 to maintain its moisture content throughout its shelf life. The formulation and method of manufacture also enables cookie pieces 14 to maintain a firmer texture, irrespective of their significantly lower water activity even after six months. This is due to the reduced water migration characteristic of brownie component 12. Brownie product 10 provides a product that is organoleptically pleasing in that it provides contrasting crunchy cookie textures with the moist/fudgy texture of a brownie and contrasting tastes among the brownie, cookie and confectionary drops. Confectionary droplets can be sweetened and flavored, for example with a vanilla flavor.

As described below, product 10 can control moisture retention and migration in shelf stable, intermediate moisture baked food products. This moisture control system has a humectant blend and a hydrophobic blend. The moisture control system includes a unique combination of food ingredients having different water affinity properties such as various sugars, syrups, cocoas, lipids, glycerin, hydrocolloids, and the like. The product is preferably able to maintain the moisture content of soft and moist baked products, and the desired organoleptic properties for a minimum of six months shelf life. One possible hydrophobic component of the product is an oil/emulsifier blend whose functionality is optimized via the order of addition and mix procedure. Organoleptic results indicate this two-component system is effective in intermediate moisture products having a water activity in the range from 0.5 to 0.75 and does not necessarily require use of preservatives or antimicrobial systems.

An exemplary composition for product 10 is set forth in Table 1 below.

TABLE 1

| | Narrow Range | | Broad Range | |
|---|---|---|---|---|
| | Percent of Dough | | Percent of Dough | |
| INGREDIENTS | From | To | From | To |
| GROUP 1 | | | | |
| brownie trim | 4.35 | 4.35 | 4.35 | 4.35 |
| ground cookie | 6.27 | 6.27 | 6.27 | 6.27 |
| water | 25.68 | 3.94 | 33.25 | 0.00 |
| GROUP 2 | | | | |
| cake flour | 13.63 | 13.63 | 13.63 | 13.63 |
| powdered sugar | 19.23 | 19.23 | 19.23 | 19.23 |
| salt | 0.20 | 0.20 | 0.20 | 0.20 |
| ethyl vanillin | 0.03 | 0.03 | 0.03 | 0.03 |
| spray dried egg whites | 1.71 | 1.71 | 1.71 | 1.71 |
| crystalline fructose | 3.41 | 8.18 | 1.70 | 10.22 |
| glycerine | 2.00 | 8.00 | 0.001 | 14.00 |
| corn syrup | 1.53 | 3.68 | 0.77 | 4.60 |
| powdered polydextrose | 1.01 | 2.43 | 0.51 | 3.04 |
| sodium bicarbonate | 0.42 | 0.42 | 0.42 | 0.42 |
| red dutched cocoa | 2.59 | 2.59 | 2.59 | 2.59 |
| black dutched cocoa | 1.94 | 1.94 | 1.94 | 1.94 |
| GROUP 3- PRE-MIXES: | | | | |
| xanthan gum | 0.01 | 0.05 | 0.001 | 0.10 |
| sodium alginate | 0.04 | 0.13 | 0.001 | 0.30 |
| methylcellulose | 0.03 | 0.25 | 0.001 | 0.50 |
| nonhydrogenated shortening | 0.48 | 1.14 | 0.24 | 1.91 |
| soy bean oil + TBQH | 3.37 | 8.10 | 1.69 | 13.50 |
| emulsifier | 0.48 | 1.14 | 0.24 | 1.91 |
| chocolate liquor | 0.71 | 1.72 | 0.36 | 2.86 |
| water | 2.51 | 2.51 | 2.51 | 2.51 |
| GROUP 4 | | | | |
| white conf. drops | 8.36 | 8.36 | 8.36 | 8.36 |
| TOTAL | 100 | 100 | 100 | 100 |

Table 1 shows one particular embodiment of the present composition and can be divided into a humectant blend, a hydrocolloid blend, a hydrophobic blend, and food ingredients. The combination of food ingredients are limited only by the imaginations of the product developers, and thus are limitless. Nevertheless, the moisture control system of these embodiments in an intermediate moisture product is the combination of a humectant blend, hydrocolloid and a hydrophobic blend. The humectant components can include glycerine and polydextrose. Other possible humectants can include other variations of glycerine, propylene glycol, glyceryl triacetate, polyols such as sorbitol, xylitol and maltitol, other polymeric polyols like polydextrose, or natural extracts like quillaia, lactic acid. Table 1 also shows hydrocolloid components of xanthan gum, sodium alginate, and methylcellulose. Other possible hydrocolloids can include guar gum, other alginates, cellulose gums, maltodextrin or hydroxyl propyl methyl cellulose. Table 1 also shows hydrophobic components as various lipids including non-hydrogenated shortening, soy bean oil+TBHQ (tertiary-butylhydroquinone), emulsifier (such as mono-, di-, tri-glycerides), chocolate liquor. It is noted that any edible lipid could be used for this component (e.g. Sunflower oil, canola oil, and the like).

A specific exemplary composition is set forth in Table 2 below.

TABLE 2

| | Percent of |
|---|---|
| INGREDIENTS | Dough |
| GROUP 1 | |
| brownie trim rework | 4.35% |
| ground cookie | 6.27% |
| water | 12.29% |
| GROUP 2 | |
| cake flour | 13.63% |
| powdered sugar | 19.23% |
| salt | 0.20% |
| ethyl vanillin | 0.03% |
| Spray dried egg whites | 1.71% |
| crystalline fructose | 6.82% |
| glycerine | 4.30% |
| corn syrup | 3.07% |
| powdered polydextrose | 2.02% |
| sodium bicarbonate | 0.42% |
| red dutched cocoa | 2.59% |
| black dutched cocoa | 1.94% |
| GROUP 3- PRE-MIXES: | |
| xanthan gum | 0.02% |
| sodium alginate | 0.09% |
| methylcellulose | 0.07% |
| nonhydrogenated shortening | 0.95% |
| soy bean oil + TBQH | 6.75% |
| emulsifier | 0.95% |
| chocolate liquor | 1.43% |
| water | 2.51% |
| GROUP 4 | |
| white confectionary drops | 8.36% |
| TOTAL | 100.00% |

The brownie product of Table 2 can be made by a specific method that improves its moisture retention and reduced moisture migration. In the embodiment of Table 2, the group 3 hydrocolloid components of xanthan gum, sodium alginate, methylcellulose and water are pre-mixed. Similarly, the hydrophobic lipid components of nonhydrogenated shortening, soy bean oil+TBQH, emulsifier, and chocolate liquor are also pre-mixed.

The overall mixing of the product can include first low mixing the Group 1 components of the brownie rework, the ground cookie and water for about 2 minutes. The Group 2 components and the Group 3 pre-mixes can all be added to the Group 1 blend and low blended for about 2 minutes. And finally, in this instance, confectionary drops can be added into the Group 1, 2 and 3 blend and low mixed for about 1 minute. This results in a composition that has a water activity rate of about 0.69 and 12 to 15 percent moisture. The product can be mixed with water at 46 degrees Celsius with a high shear mixer leaving a dough temperature of about 30 degrees Celsius. In this process, the humectant/hydrocolloid matrix is created first and then it is coated with the hydrophobic oil/emulsifier blend. This hydrophobic surface coating on an already formed matrix creates the desired moisture barrier. The humectants/hydrocolloids inhibit moisture migration.

An exemplary method to bake, cut and package the composition of Table 2 is set forth in Table 3 below. Product 10 can be baked using a panning process to resemble “home-baked” brownies (i.e., appearance and texture). The product alternately can be cut and individually wrapped in high moisture barrier clear film.

TABLE 3

| Pre-bakinq Procedures: | Amount of batter/tray | 9.8 | lb. |
|---|---|---|---|
| Depositing Batter & | Amount of Cookie pcs/tray | 0.4 | lb. |
| Cookie Topping | | | |
| Baking | Oven: | | |
| | Time Bake | 30.00 | min |
| | Bake Profile: | | |
| | Zone 1 | 224 C. +/− 5° C. | |
| | Zone 2 | 221 C. +/− 5° C. | |
| | Zone 3 | 221 C. +/− 3° C. | |
| | Product internal temp post | 99 C. | |
| | bake | | |
| Cooling | Cooling Time | 60-70 | min |
| Post-Cooling | Weight of 1 tray post bake | 4.45 | kg |
| | Weight of 1 brownie | 85 | gms |

| | | |
|---|---|---|
| | Cutters Used | 48 ct/36 ct |
| | Brownie Dimensions | 6.35 × 7.6 cm |
| Physical-chemical | Water Activity | 0.67 |
| parameters | % Moisture | 13% |
| | pH | 7.3 |

Using the present method, many alternate embodiments are possible, such as one shown in Table 4 having no rework component.

TABLE 4

| | Percent |
|---|---|
| INGREDIENTS | of Dough |
| GROUP 1 | |
| cake flour | 15.54% |
| powdered sugar | 21.93% |
| salt | 0.23% |
| ethyl vanillin | 0.04% |
| spray dried egg whites | 1.94% |
| crystalline fructose | 7.77% |
| glycerine | 4.90% |
| corn syrup | 3.50% |
| powdered polydextrose | 2.31% |
| sodium bicarbonate | 0.48% |
| red dutched cocoa | 2.96% |
| black dutched cocoa | 2.21% |
| water | 14.97% |
| GROUP 2 | |
| xanthan gum | 0.02% |
| sodium alginate | 0.10% |
| methylcellulose | 0.07% |
| nonhydrogenated shortening | 1.09% |
| soy bean oil + TBHQ | 7.69% |
| emulsifier | 1.09% |
| chocolate liquor | 1.63% |
| GROUP 3 | |
| white confectionary drops | 9.53% |
| TOTAL | 100.00% |

In this embodiment all, Group components can be mixed on low for 2 minutes. The Group 2 pre-mixes can be added in by first adding the hydrocolloid pre-mix of xanthan, alginate and methylcellulose in water prior to adding the lipid premix of shortening, oil, emulsifier, and liquor. Lastly, optional confectionary drops can be added. Other embodiments can include the addition modified starch or the elimination sodium alginate. In reality, there are practically limitless intermediate moisture baked food ingredient combinations that could benefit from this moisture control system.

While the products and methods have been described in conjunction with specific embodiments, it is evident that many alternatives, modifications, and variations will be apparent to those skilled in the art in light of the foregoing description.

We claim:

1. A shelf life extending moisture control system for an intermediate moisture developed food composition, comprising:
a humectant blend;
a hydrocolloid blend; and
a hydrophobic blend.

2. The moisture control system of claim 1, wherein the humectant blend is selected from the list comprising: glycerine, propylene glycol, glyceryl triacetate, polyols, xylitol, maltitol, polymeric polyols, polydextrose, natural extracts of quillaia, and natural extracts of lactic acid.

3. The moisture control system of claim 2, wherein the humectant blend comprises glycerine and polydextrose.

4. The moisture control system of claim 3, wherein the humectant blend comprises about 0.001 to 14 percent weight glycerine and about 0.51 to 3 percent weight polydextrose.

5. The moisture control system of claim 1, wherein the hydrocolloid blend is selected from the list comprising: xanthan gum, guar gum, alginates, cellulose gums, maltodextrin and hydroxyl propyl methyl cellulose.

6. The moisture control system of claim 5, wherein the hydrocolloid blend comprises: xanthan gum, sodium alginate, and methyl cellulose.

7. The moisture control system of claim 6, wherein the hydrocolloid blend comprises about 0.001 to 0.1 percent weight xanthan gum, about 0.001 to 0.3 percent weight sodium alginate, and about 0.001 to 0.50 percent weight methyl cellulose.

8. The moisture control system of claim 1, wherein the hydrophobic blend comprises an edible lipid.

9. The moisture control system of claim 7, wherein the hydrophobic blend comprises: non-hydrogenated shortening, soy bean oil+TBHQ (tertiary-butylhydroquinone), emulsifier, and liquor.

10. The moisture control system of claim 9, wherein the hydrophobic blend comprises about 0.24 to 1.9 percent weight non-hydrogenated shortening, about 1.69 to 13.5 percent soy bean oil+TBHQ (tertiary-butylhydroquinone), about 0.36 to 2.85 percent weight emulsifier, and about 0.36 to 2.85 percent weight liquor.

11. An intermediate moisture developed food composition, comprising:
food ingredients;
water; and
a shelf life extending moisture control system for an intermediate moisture developed food composition having a humectant blend, a hydrocolloid blend, and a hydrophobic blend.

12. The food composition of claim 11, comprising:
about 94.7 to 26.9 percent weight food ingredients;
about 2.5 to 35 percent weight water;
about 0.52 to 17 percent weight humectant blend;
about 0.003 to 0.9 percent weight hydrocolloid blend;
about 2.3 to 20.2 percent weight hydrophobic blend; and
wherein the composition has a water activity (A_{W}) range of about 0.5 to 0.75.

13. A method to develop an intermediate moisture food composition having a shelf life extending moisture control system, comprising the steps of:
pre-mixing a humectant blend;
pre-mixing a hydrocolloid blend; and
mixing food ingredients with the humectant blend and the hydrocolloid blend to form a matrix; and
coating the matrix with the hydrophobic blend.

14. The method of claim 13, further comprising the steps of forming the composition;
baking the composition;
post-cooling;
cutting; and
packaging the composition an air tight package.

15. The method of claim 13, wherein the humectant blend is the blend of claim 3, the hydrocolloid blend is the blend of claim 6, and the hydrophobic blend is the blend of claim 9.
